(19) United States
(12) Patent Application Publication
(10) Pub. No.: US 2006/0056633 A1
(43) Pub. Date: Mar. 16, 2006

(54) Real-time decryption system and method

(75) Inventor: Jung-Tsan Hsu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/077,843

(22) Filed: Mar. 11, 2005

(30) Foreign Application Priority Data
Sep. 11, 2004 (TW) 93134086

(51) Int. Cl. H04L 9/32; H04K 1/00; G06K 9/00; G06F 17/30; G06F 15/16; G06F 7/04; G06F 7/58; G06K 19/00

(52) U.S. Cl. 380/270; 726/4

(57) ABSTRACT

A real-time decryption system and method utilizing Content Addressable Memory (CAM) for synchronously comparing network addresses in wireless communications. First, a network address table and a decryption key table are provided, wherein the decryption key table comprises a plurality of decryption keys, and the network address table comprises a plurality of network addresses correspondingly. Thereafter, a packet is received, wherein the packet comprises a source address and a ciphertext. The source address is then compared with the network addresses, thus a decryption key from a location of the decryption key table can be obtained according to the network address if one network address matches the source address. At last, the ciphertext is decrypted with the decryption key to generate a plaintext.

The invention relates to a real-time decryption system and method, and in particular, to a method and system utilizing Content Addressable Memory (CAM) for wireless communication.

### BACKGROUND

Cryptography is a basis of information security in communication technologies. For example, in the standard IEEE 802.11, a shared key is provided for two nodes to communicate through encryption and decryption. Therefore memory capacity is essential for key management, although, especially when communicating with numerous nodes, the cost for storing and locating a key grows significantly. FIG. 1a shows a conventional data structure of a packet 104 comprising a source address 106, a destination address 108, and a ciphertext 110. When a system receives a packet 104, a specific key is required to decrypt the ciphertext 110. FIG. 1b is a block diagram of a conventional memory device 102 storing pairs of source addresses and corresponding keys. The source addresses in the memory device 102 are serially compared with the source address 106 until a match is found.

The advantage of the architecture shown in FIG. 1b is, when a specific network address in the memory device 102 is found to match, the corresponding key can be directly retrieved from the next slot. The serial search, however, is not efficient for a memory device 102 comprising numerous data pairs. The cost of searching grows in proportion to the number of data pairs stored. Thus an improved design is desirable.

### SUMMARY

An embodiment provides a real-time decryption method for wireless communication comprising the following steps. First, a network address table and a decryption key table are provided. The decryption key table comprises a plurality of decryption keys, and the network address table comprises a plurality of network addresses correspondingly. Thereafter, a packet comprising a source address and a ciphertext is received. The source address is then compared with the network addresses. If one network address matches the source address, a decryption key is obtained from a location of the decryption key table according to the network address. The ciphertext is decrypted with the decryption key to generate a plaintext.

Each network address maps to a corresponding decryption key in the decryption key table. The packet is discarded if no match is found. The network address table and the decryption key table are stored in different locations of one memory device, or in different memory devices. The comparison step synchronously compares the source address with all network addresses in the network address table, and the network address table is stored in a Content Addressable Memory (CAM) device.

Further provided is an embodiment of a real-time decryption system receiving a packet comprising a source address and a ciphertext. The real-time decryption system comprises a first memory device, a second memory device, and a decryption module. The first memory device, storing a plurality of network addresses, is capable of comparing the source address with the network addresses and generating a match result. The second memory device storing a plurality of decryption keys is capable of providing a decryption key according to the match result. The decryption module decrypts the ciphertext with the decryption key to generate a plaintext.

The first memory device synchronously outputs match results of each network address. A match result is set to a first bit if matched, and conversely, to a second bit if not matched. The real-time decryption system further comprises a decoder for determining the location of the network address where its match result has the first bit, and obtaining the decryption key in the decryption key table according to the location.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1a shows a conventional data structure of a packet;

FIG. 1b is a block diagram of a conventional memory device storing data;

FIG. 2 shows an embodiment of the system structure; and

FIG. 3 shows an embodiment of the real-time decryption method.

### DETAILED DESCRIPTION OF THE INVENTION

A detailed description of the present invention is provided in-the following.

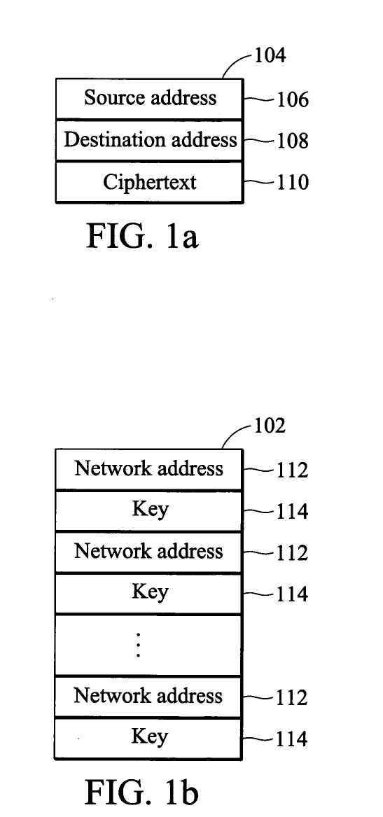

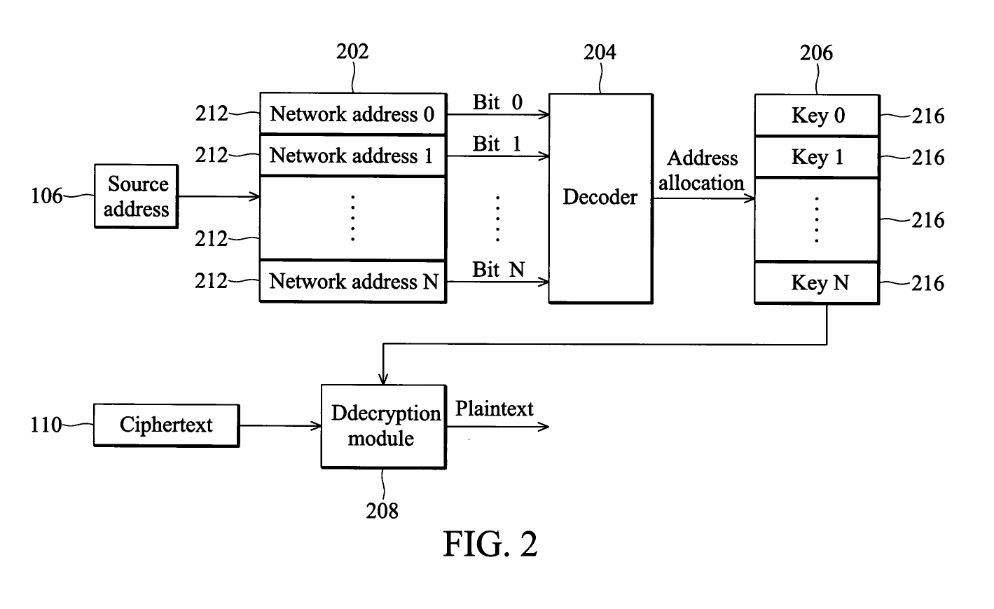

FIG. 2 is an embodiment of the system structure utilizing Content Addressable Memory (CAM). In the embodiment, the CAM 202 comprises a plurality of network addresses 212 for communication of corresponding plurality of nodes. A plurality of keys 216 corresponding to the network addresses 212 are stored in memory device 206. When the system receives a packet 104 shown in FIG. 1a, the source address 106 therein is input to the CAM 202. The CAM 202 is then switched to a parallel comparison mode for synchronously comparing the source address 106 and the plurality of network addresses 212, and each comparison generating a result indicating “not matched” by bit 0 and “matched” by bit 1. The plurality of source address 106 and key 216 are previously configured through key management schemes or known measures, allowing communication with legal nodes registered therein, therefore packets 104 with no matching source address 106 are taken as illegal packets and discarded, ensuring security of the system. In an ordinary legal communication, the outputs of the CAM 202 comprises only one “matched”, and others are “not matched”, thus the corresponding steps are then processed based thereon.

The results are delivered to a decoder 204 for location calculation. For example, if the second result is “matched”, then it is the second slot of the memory device 206 where the correct key 216 resides. Since the correct key 216 is obtained therefrom, the decryption module 208 can then decrypt the ciphertext 110 with the key 216 to generate a plaintext.

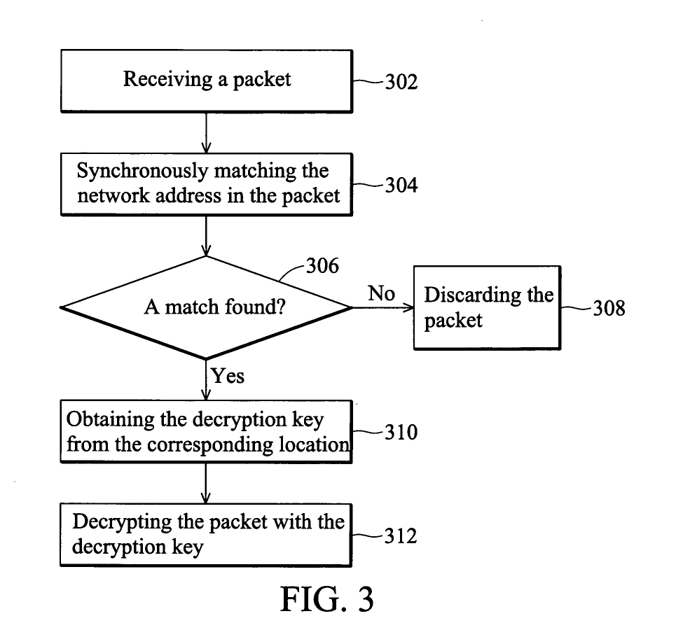

FIG. 3 shows an embodiment of the real-time decryption method. A system is provided, comprising a CAM 202 storing a plurality of network addresses 212, and a memory device 206 storing a plurality of key 216 corresponding to the network addresses 212. In step 302, a packet 104 comprising a source address 106 and a ciphertext 110, is received. In step 304, the packet 104 is compared with the network addresses 212 stored in CAM 202. In step 306, it is determined whether a network addresses 212 matches the packet 104. If no match, the process goes to step 308 and discards packet 104. Conversely, if a match is found, a corresponding key 216 is obtained from the memory device 206 in step 310, and in step 312, the ciphertext 110 is decrypted into plaintext by the key 216.

The cryptographic schemes utilized in the embodiment can be a symmetric cryptography system or asymmetric cryptography system. The memory device 206 can be implemented by Dynamic Read All Memory (DRAM) or Static Read All Memory (SRAM). The decoder 204 and decryption module 208 can be implemented by a central processing unit cooperating with software, or through Application Specific Integrated Circuit (ASIC). The CAM 202 is a market available product provided by vendors such as Net Logic and Altera APEX.

The data structures of the network addresses and keys in the memory are stored separately in two different memory devices (or two separate locations of a memory device). Moreover, only the memory for storing the network addresses is used to perform the comparison with the address of the received packet. Therefore, different to the prior arts, the invention need not read the keys in the memory during the comparison, and then the efficiency is improved. Further, while the network address corresponding to the received packet is not located near the top of the memory for saving the network addresses, the advantageous is clearer for more time for reading the keys during the comparison is saved by the invention.

In addition, the invention could use the character of the CAM, is capable of parallel comparing many data, to store many network addresses in a CAM. Therefore, the invention need to compare the address of the received packet serially with each of the network addresses, but can compare it with the network address simultaneously. Hence, the invention significantly reduces the need of processing time as the conventional serial comparison takes, especially while the corresponding network address is not located near the top of the memory for storing the network addresses.

In summery, as described in above embodiments, the invention amends the way to store the network addresses and the ways in the memory, and optionally use the parallel comparison character of the CAM. Hence, the time and resources consumed during comparison is significantly reduced, and than a wireless communication system capable of real-time decryption, is established.

While the invention has been described by way of example and in terms of the preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A real-time decryption method for wireless communication, comprising:
providing a network address table and a decryption key table, wherein the decryption key table comprises a plurality of decryption keys, and the network address table comprises a plurality of network addresses correspondingly;
receiving a packet, wherein the packet comprises a source address and a ciphertext;
comparing the source address with the network addresses;
obtaining a decryption key from a location of the decryption key table according to the network address if one network address matches the source address; and
decrypting the ciphertext with the decryption key to generate a plaintext.

2. The real-time decryption method as claimed in claim 1, wherein each of the network addresses maps to a corresponding decryption key in the decryption key table.

3. The real-time decryption method as claimed in claim 1, wherein if the comparison step does not find any match, discarding the packet.

4. The real-time decryption method as claimed in claim 1, wherein the network address table and the decryption key table are stored in different locations on one memory device.

5. The real-time decryption method as claimed in claim 1, wherein the network address table and the decryption key table are stored in different memory devices.

6. The real-time decryption method as claimed in claim 1, wherein the comparison step further comprises synchronously comparing the source address with all network addresses in the network address table.

7. The real-time decryption method as claimed in claim 6, wherein the network address table is stored in a Content Addressable Memory (CAM) device.

8. The real-time decryption method as claimed in claim 1, wherein the comparison step comprises:
synchronously outputting match results of each network address, wherein:
a match result is set to a first bit if matched; and
a match result is set to a second bit if not matched.

9. The real-time decryption method as claimed in claim 8, wherein the obtaining step comprises:
calculating the location of the network address where its match result has the first bit; and
obtaining the decryption key in the decryption key table according to the location calculated.

10. A real-time decryption system, receiving a packet comprising a source address and a ciphertext, comprising:
a first memory device, storing a plurality of network addresses, capable of comparing the source address with the network addresses and generating a match result;
a second memory device, storing a plurality of decryption keys, capable of providing a decryption key according to the match result; and
a decryption module, decrypting the ciphertext with the decryption key and generating a plaintext.

11. The real-time decryption system as claimed in claim 10, wherein:
each of the network addresses maps to a corresponding decryption key in the decryption key table.

12. The real-time decryption system as claimed in claim 10,
the first memory device synchronously compares the source address with all network addresses in the network address table.

13. The real-time decryption system as claimed in claim 12, wherein the first memory device is a Content Addressable Memory (CAM) device.

14. The real-time decryption system as claimed in claim 13, wherein the first memory device synchronously outputs match results of each network address, wherein:
a match result is set to a first bit if matched; and
a match result is set to a second bit if not matched.

15. The real-time decryption system as claimed in claim 14, further comprising a decoder, determining the location of the network address where its match result has the first bit, and obtaining the decryption key in the decryption key table according to the location.

16. The real-time decryption system as claimed in claim 14, wherein the second memory device is Static Read All Memory (SRAM) and Dynamic Read All Memory (DRAM).
